(19) United States
(12) Patent Application Publication
(10) Pub. No.: US 2021/0062110 A1
(43) Pub. Date: Mar. 4, 2021

(54) COST-EFFECTIVE LAUNDRY DETERGENT COMPOSITIONS COMPRISING GREEN COMPONENTS

(71) Applicant: Frey Brothers, Inc., Brooklyn, NY (US)

(72) Inventors: Erin Robert Frey, Annapolis, MD (US); Leif Alexander Frey, Brooklyn, NY (US)

(21) Appl. No.: 17/003,115

(22) Filed: Aug. 26, 2020

Related U.S. Application Data
(60) Provisional application No. 62/891,794, filed on Aug. 26, 2019.

(51) Int. Cl. C11D 1/29; C11D 1/40; C11D 1/66; C11D 3/20; C11D 3/22; C11D 3/37; C11D 3/04; C11D 3/386; C11D 3/382; C11D 3/50; C11D 11/00; C11D 17/00; C11D 17/06; C11D 3/33

(52) U.S. Cl. CPC C11D 1/29; C11D 3/33; C11D 1/667; C11D 3/2044; C11D 3/222; C11D 3/3761; C11D 3/3765; C11D 3/044; C11D 3/38609; C11D 3/38618; C11D 3/38627; C11D 3/2079; C11D 3/382; C11D 3/50; C11D 11/0017; C11D 11/0094; C11D 17/003; C11D 17/0047; C11D 17/06; C11D 1/40

(57) ABSTRACT

Provided herein is a green laundry detergent composition that is pH neutral and comprises a powerful cleansing surfactant, an organic and sustainable broad-spectrum antimicrobial agent, a high purity natural, renewable and biodegradable chelate, an emulsion polymer, a pH adjuster, enzymes, and water. Also provided are methods of producing the green laundry detergent composition and methods comprising the use of the green laundry detergent composition.

### CROSS-REFERENCE TO RELATED APPLICATIONS

This application claims the benefit of U.S. Provisional Patent Application No. 62/891,794, filed Aug. 26, 2019, which are all hereby incorporated by reference in their entirety.

### FIELD

Provided herein are laundry detergent compositions that are cost-effective and comprise green components, which are less harmful to the ecosystem and the environment than common detergents. The disclosed laundry detergent compositions in some embodiments are less harsh on fibers, do not fade the colors of colored fabric as easily, can be used in small amounts to effectively clean soiled material and remove stains, and are not skin irritating. Therefore, the disclosed laundry detergent compositions may be more suitable for use by subjects with sensitive skin. Also provided are methods of making and methods of using the disclosed laundry detergent compositions.

### BACKGROUND

Consumers have very high expectations with regard to the ability of laundry detergents to effectively clean soiled materials and remove stains from fabrics. Doing the laundry often involves removing soils of different nature from fibers. For example, soils may be water-soluble soils, such as sugars, inorganic salts and urea; hydrophobic soils, such as animal fats, vegetable oils, sebum, and grease; protein soils, such as blood, milk and eggs; particulate soils, such as rust and metal; and bleachable soils, such as wine, caffeinated drinks and fruit juices. Therefore, laundry detergents often contain chelating agents, surfactants, enzymes, conditioning agents, fragrances, pH modifiers, anti-deposition agents, anti-crease agents, antimicrobial agents, germicides, fungicides, and antioxidants, to say the least, to be highly effective and ensure proper cleaning.

Many of the components currently found in laundry detergents are synthetic and do not derive from plants, and therefore they present a challenge to the environment and the ecosystem. On the other hand, environment-friendly laundry detergents currently on the market have lacked the same cleaning power of less environment-friendly top-rated detergents. Therefore, a need exists for “green” laundry detergents that can sustainably deliver cleaning power without harming the environment.

### SUMMARY

It is shown herein that the disclosed green detergent compositions successfully clean fibers, are cost-effective and have a better carbon footprint because they are highly concentrated, and are more eco-friendly because their components are sustainable and more readily biodegradable than common detergents. Based on these findings, a green detergent composition for laundering fabrics is provided. The green detergent composition is pH neutral and comprises a powerful cleansing surfactant, an organic and sustainable broad-spectrum antimicrobial agent, a high purity natural, renewable and biodegradable chelate, an emulsion polymer, a pH adjuster, enzymes, and water. In some examples, natural fragrances and/or natural essential oils may be included.

In some examples, the disclosed green laundry detergent composition may comprise 20-25% (w/v) powerful cleansing surfactant; 0.4-0.8% (w/v) organic and sustainable broad-spectrum antimicrobial agent; 1.2-1.8% (w/v) high purity natural, renewable and biodegradable chelate; 1.5-2.0% (w/v) emulsion polymer; 0.025-0.04% (w/v) pH adjuster; 0.1-0.2% (w/v) enzymes; and up to 70% (w/v) water. In some examples, the disclosed green laundry detergent composition may additionally comprise 2.7-3.5% (w/v) natural fragrances. In some alternative examples, the disclosed green laundry detergent composition may additionally comprise 2.5-7% (w/v) fragrances, wherein 3-6% of the fragrances are natural. In some examples, the disclosed green laundry detergent composition may additionally comprise 0.8-2.0% (w/v) natural essential oils.

In some examples, the organic and sustainable broad-spectrum antimicrobial agent is a synergistic blend of benzoic acid in sorbitan caprylate and propanediol; the high purity natural, renewable and biodegradable chelate is tetrasodium glutamate diacetate; the emulsion polymer is an EPA-safe and highly efficient, hydrophobically-modified alkali-swellable emulsion polymer, such as acrylates/beheneth-25 methacrylate copolymer (e.g., NOVETHIX™ L10 polymer); the pH adjuster is sodium hydroxide; and the enzymes comprise one or more of lipase, alpha-amylase and protease. In some examples, natural fragrances comprise perfumes. In some examples, natural essential oils comprise one or more of cedarwood essential oil, balsam fir essential oil, and lavender essential oil. In some examples, the powerful cleansing surfactant is sodium laureth sulfate. In some alternative examples, the cleaning surfactant is instead sodium lauryl sulfate or an alkyl polyglycoside.

Thus, in some examples the green laundry detergent composition comprises 21.719% (w/v) sodium laureth sulfate; 1.493% (w/v) sorbitan caprylate in propanediol and benzoic acid; 1.9% (w/v) tetrasodium glutamate diacetate; 2.986% (w/v) acrylates/beheneth-25 methacrylate copolymer; 0.543% (w/v) sodium hydroxide; 0.027% (w/v) lipase; 0.03% (w/v) alpha-amylase; 0.033% (w/v) protease; 6.027% (w/v) natural fragrances; 0.03% (w/v) cedarwood essential oil; 0.027% (w/v) balsam fir essential oil; 0.027% (w/v) lavender essential oil; and 65.157% water.

In some examples, the detergent compositions provided herein may further comprise additional ingredients. Suitable additional ingredients include, but are not limited to, natural bleaching agents, natural antibacterial agents, color stabilizers, natural fatty acids, such as tartaric acid, oleic acid, lauric acid, maleic acid, and any combination thereof, and one or more natural essential oils, such as L-menthol, chuanxiong oil, clove oil, cinnamon oil, turpentine oil, eucalyptus oil, and any combination thereof.

The disclosed detergent compositions may be in liquid or in solid form. Liquid detergent compositions may be in the form of gel, hydrogel, emulsion, cream or water solutions. Solid forms may comprise tablets, powder, single-phase or multi-phase unit doses, pouches, pods, paste, bars, or flakes.

The disclosed detergent compositions are suitable for use in hand washing as well as in laundry machines.

The detergent compositions provided herein present several attractive features and desirable properties that make them suitable for washing a variety of fabrics. For example, the detergent composition is designed to be less irritating to the skin and reduce the chances of rash, redness, inflammation or discoloration of the skin, making the laundry detergent compositions particularly suitable to wash fabrics that come in contact with the skin of the elderly, infant and pediatric populations, who tend to have sensitive skin.

In addition, because the components in the detergent compositions are highly concentrated, the laundry detergent compositions provided herein can be used in small amounts, and are therefore very cost effective. Moreover, the laundry detergent compositions provided herein contain green ingredients that synergistically act together and are not harsh on fabrics and do not fade colors, and thus are eco-friendly.

Also provided herein is a method of making disclosed detergent compositions. The method comprises first adding the cleansing surfactant to water to obtain a mixture and stirring the mixture at or substantially near room temperature (25° C.); gradually adding the organic and sustainable broad-spectrum antimicrobial agent, the high purity natural, renewable and biodegradable chelate and the emulsion polymer to the mixture, and stirring the mixture until the emulsion polymer is dissolved; adjusting the pH to 7 with the pH adjuster; then adding the enzymes and stirring until an even mixture is obtained; adding the natural fragrances and the natural essential oils and stirring to obtain an even mixture with the desired viscosity.

In some examples, the disclosed method produces a detergent composition that may comprise 20-25% (w/v) powerful cleansing surfactant; 0.4-0.8% (w/v) organic and sustainable broad-spectrum antimicrobial agent; 1.2-1.8% (w/v) high purity natural, renewable and biodegradable chelate; 1.5-2.0% (w/v) emulsion polymer; 0.025-0.04% (w/v) pH adjuster; 0.1-0.2% (w/v) enzymes; 2.7-3.5% (w/v) natural fragrances; 0.8-2.0% (w/v) natural essential oils; and up to 70% (w/v) water. In some additional or alternative examples, the disclosed green laundry detergent composition may comprise 2.5-7% (w/v) fragrances, wherein 3-6% of the fragrances are natural.

In some examples, the organic and sustainable broad-spectrum antimicrobial agent is a synergistic blend of sorbitan caprylate in benzoic acid and propanediol; the high purity natural, renewable and biodegradable chelate is tetrasodium glutamate diacetate; the emulsion polymer is an EPA-safe and highly efficient, hydrophobically-modified alkali-swellable emulsion polymer, such as acrylates/beheneth-25 methacrylate copolymer (e.g., NOVETHIX™ L10 polymer); the pH adjuster is sodium hydroxide; and the enzymes comprise one or more of lipase, alpha-amylase and protease. In some examples, natural fragrances comprise perfumes. In some examples, natural essential oils comprise one or more of: cedarwood essential oil, balsam fir essential oil, and lavender essential oil. In some examples, the cleansing surfactant is sodium laureth sulfate. In some alternative embodiments, the cleansing surfactant may instead be sodium lauryl sulfate or an alkyl polyglycoside.

In some examples, the disclosed method produces a green detergent composition that comprises 21.719% (w/v) sodium laureth sulfate; 1.493% (w/v) sorbitan caprylate in propanediol and benzoic acid; 1.9% (w/v) tetrasodium glutamate diacetate; 2.986% (w/v) acrylates/beheneth-25 methacrylate copolymer; 0.543% (w/v) sodium hydroxide; 0.027% (w/v) lipase; 0.03% (w/v) alpha-amylase; 0.033% (w/v) protease; 6.027% (w/v) natural fragrances; 0.03% (w/v) cedarwood essential oil; 0.027% (w/v) balsam fir essential oil; 0.027% (w/v) lavender essential oil; and 65.157% water.

In some examples, the method provided herein may further comprise adding additional ingredients. Suitable additional ingredients include, but are not limited to, natural bleaching agents, natural antibacterial agents, color stabilizers, natural fatty acids, such as tartaric acid, oleic acid, lauric acid, maleic acid, and any combination thereof, and one or more natural essential oils, such as L-menthol, chuanxiong oil, clove oil, cinnamon oil, turpentine oil, eucalyptus oil, and any combination thereof.

The method provided herein produces a laundry detergent composition that comprises natural components in high concentration, thus making the laundry detergent compositions provided herein very cost effective. Moreover, the laundry detergent compositions produced by the method provided herein contain green ingredients that synergistically act together and are not harsh on fabrics and do not fade colors, and thus are eco-friendly.

Also provided herein is a method of using the disclosed detergent compositions, wherein the method comprises diluting the disclosed detergent composition in water to form a detergent composition solution, adding soiled material to the detergent composition solution, soaking and shaking the soiled material in the detergent composition solution for 30 minutes to 2 hours, rinsing the material with water, and squeezing the water out of the material. The method may be performed by hand or with a washing machine. Example of soiled material that may be washed by the disclosed method include, but are not limited to, natural or artificial fibers, including natural, artificial, and synthetic fibers, such as, but not limited to, cotton, linen, wool, polyester, nylon, silk, acrylic, and any combinations thereof.

The foregoing and other features of the disclosure will become more apparent from the following detailed description of several embodiments.

### BRIEF DESCRIPTION OF THE DRAWINGS

FIG. 1 is a flow chart illustrating an exemplary method 100 of making a green laundry detergent composition, in accordance with some embodiments.

### DETAILED DESCRIPTION

The following explanations of terms and methods are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. For example, reference to “comprising a therapeutic agent” includes one or a plurality of such therapeutic agents. The term “or” refers to a single element of stated alternative elements or a combination of two or more elements, unless the context clearly indicates otherwise. For example, the phrase “A or B” refers to A, B, or a combination of both A and B. Furthermore, the various elements, features and steps discussed herein, as well as other known equivalents for each such element, feature or step, can be mixed and matched by one of ordinary skill in this art to perform methods in accordance with principles described herein. Among the various elements, features, and steps some will be specifically included and others specifically excluded in particular examples.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. All references cited herein are incorporated by reference in their entirety.

In some examples, the numbers expressing quantities of ingredients, properties such as molecular weight, reaction conditions, and so forth, used to describe and claim certain embodiments are to be understood as being modified in some instances by the term “about” or “approximately.” For example, “about” or “approximately” can indicate +/−20% variation of the value it describes. Accordingly, in some embodiments, the numerical parameters set forth herein are approximations that can vary depending upon the desired properties for a particular embodiment. Notwithstanding that the numerical ranges and parameters setting forth the broad scope of some examples are approximations, the numerical values set forth in the specific examples are reported as precisely as practicable. The recitation of ranges of values herein is merely intended to serve as a shorthand method of referring individually to each separate value falling within the range.

To facilitate review of the various embodiments of this disclosure, the following explanations of specific terms are provided:

Analog: A compound having a structure similar to another, but differing from it, for example, in one or more atoms, functional groups, or substructure.

Anesthetic agent: An active agent that causes reduction or loss of sensation.

Antibiotic: A chemical substance capable of treating bacterial infections by inhibiting the growth of, or by destroying existing colonies of bacteria and other microorganisms.

Anti-Fungal Agent: An active agent capable of inhibiting the growth of or destroying fungi.

Anti-Inflammatory Agent: An active agent that reduces inflammation and swelling.

Antioxidant: An active agent that inhibits oxidation or reactions promoted by oxygen or peroxides.

Anti-Protozoal Agent: An active agent capable of inhibiting the growth of or destroying protozoa microorganisms.

Antipruritic Agent: An active agent that reduces, eliminates or prevents itching.

Anti-Viral Agent: An active agent that inhibits the replication of or destroys viruses.

Bleach Alternative: A non-toxic substitute to bleach. Bleach alternatives include, but are not limited to, hydrogen peroxide, sodium perborate, sodium percarbonate, tetraacetylenediamine (TAED), baking soda, lemon juice, vinegar, borax, tea tree oil, castile soap, and any mild oxidizing agent, such as OxiClean.

Contacting: Placement in direct physical association; includes both in solid and liquid form.

Control: A reference standard. In some examples, a control is a known value or range of values, such as one indicative of a particular effect. In some examples, a control is a value or range of values, indicating a response in the absence of one or more components.

Crosslinked: A composition containing intramolecular and/or intermolecular crosslinks, whether arising through covalent or non-covalent bonding. “Non-covalent” bonding includes both hydrogen bonding and electrostatic (ionic) bonding.

Drug or Active Agent: A chemical substance or compound that induces a desired pharmacological or physiological effect, and includes agents that are therapeutically effective, prophylactically effective, or cosmeceutically effective. The terms also encompass pharmaceutically acceptable, pharmacologically active derivatives and analogs of those active agents specifically mentioned herein, including, but not limited to, salts, esters, amides, prodrugs, active metabolites, inclusion complexes, analogs, and the like. Suitable active agents that may be incorporated into the disclosed laundry detergent compositions include, but are not limited to, skin detoxicants; anesthetic agents; anti-acne agents; anti-allergic agents; anti-asthmatic agents; anti-bacterial agents; anti-fungal agents; anti-infective agents such as antibiotics and antiviral agents; anti-inflammatory agents; anti-keratinizing agents; antimicrobial agents; anti-psoriatic agents; bacteriostatic and bactericidal agents; and the like.

Effective amount: The amount of an active agent (alone or with one or more other active agents) sufficient to induce a desired effect, such as to improve cleansing and spot removal. Effective amounts of an active agent, alone or with one or more other active agents, can be determined in many different ways, such as assaying for complete removal of soiled material.

Emulsifying Agents: Surfactants that reduce the interfacial tension between oil and water, minimizing the surface energy through formation of globules. Examples include, but are not limited to, glyceryl monostearate, methylcellulose, sodium laureth sulfate, sodium lauryl sulfate, an alkyl polyglycoside, sodium oleate, sorbitan monopalmitate, sorbitan monostearate, sorbitan tristrearate, tragacanth, triethanolamine oleate, polyethylene sorbitan monolaurate, poloxamer, and any combination thereof.

Enzymes: Enzymes are usually added to detergent compositions to degrade stubborn stains composed of proteins, such as milk, cocoa, blood, egg yolk, and grass, fats, such as chocolate and oils, starch, such as flour and potato stains, and cellulose, such as vegetable and fruit stains. Proteases are used to remove protein stains. Lipases are used to remove fat and grease stains. α-amylases are used to remove carbohydrate stains, and cellulases are used to remove cellulose stains. Enzymes are active at lower water temperatures (37° C.), and become inactivated at higher temperatures.

Fragrance or Perfume: Fragrances or perfume may include, but are not limited to, synthetic or natural esters, ethers, aldehydes, ketones, alcohols, hydrocarbons, acids, carboxylic esters, aromatic hydrocarbons, aliphatic hydrocarbons, saturated and/or unsaturated hydrocarbons, and any mixtures thereof. Fragrance aldehydes and fragrance ketones may have an aliphatic, cycloaliphatic, aromatic, ethylenically unsaturated structure or a combination of these structures. Thy may also include heteroatoms or polycyclic structures with suitable substituents, such as hydroxyl groups or amino groups. Fragrances and perfumes may also include compounds from plant sources, such as pine, citrus, lemon, balm oil, mint oil, cinnamon leaf oil, lime blossom oil, or the like, and essential oils, such as cedarwood oil, silver fir oil, silver fir cone oil, eucalyptus oil, fennel oil, pine needle oil, gingergrass oil, ginger oil, chamomile oil, camphor oil, cardamom oil, pine needle oil, spearmint oil, lavender oil, lemongrass oil, lery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, citrus oil, cypress oil, and the like.

Green Chemistry: The design of chemical products and processes that reduce or eliminate the use or generation of substances hazardous to the environment. Green chemistry applies across the life cycle of a chemical product, including its design, manufacture, use, and ultimate disposal. Under the Environmental Protection Agency (EPA) definition, green chemistry, also known as sustainable chemistry, prevents pollution at the molecular level, applies innovative scientific solutions to real-world environmental problems, results in source reduction because it prevents the generation of pollution, reduces the negative impacts of chemical products and processes on human health and the environment, lessens and sometimes eliminates hazard from existing products and processes, and designs chemical products and processes to reduce their intrinsic hazards.

Hydrogel: A water-swellable polymeric matrix that can absorb a substantial amount of water to form elastic gels. The matrix is a three-dimensional network of macromolecules held together by covalent or non-covalent crosslinks. Upon placement in an aqueous environment, dry hydrogels swell to the extent allowed by the degree of cross-linking.

Hydrogel Composition: A composition that either contains a hydrogel or is entirely composed of a hydrogel. Thus, “hydrogel compositions” encompass not only hydrogels per se but also compositions that comprise a hydrogel and one or more non-hydrogel components or compositions, e.g., hydrocolloids, which contain a hydrophilic component (which may contain or be a hydrogel) distributed in a hydrophobic phase.

Hydrophilic: A polymer, substance or compound that is capable of absorbing more than 10%/w of water at 100% relative humidity (rh).

Hydrophobic: A polymer, substance or compound that is capable of absorbing no more than 1%/w of water at 100% relative humidity (rh).

Hygroscopic: A polymer, substance or compound that is capable of absorbing more than 20 wt % of water at 100% relative humidity (rh).

Inhibiting a condition: Reducing, slowing, or even stopping the development of a condition, for example, irritation to the skin or development of rash, redness, inflammation or discoloration of the skin in a subject upon contact with a fabric treated with the disclosed laundry detergent composition.

Keratolytic Agent: An agent that that thins or softens the skin. Exemplary keratolytic agents include lactic acid, allantoin, benzoyl peroxide, salicyclic acid, sulfur, tretinoin, fluorouracil, trichloroacetic acid, and glycolic acid.

Lipophilic: A substance or compound that has an affinity for a non-polar environment compared to a polar or aqueous environment.

Matrix: A three dimensional network of polymeric fibers that contains pores. The structural parameters of the pores, including the pore size, porosity, pore interconnectivity/tortuosity and surface area, affect how active agents dispersed in the matrix move in and out of the matrix.

Oil: Any fatty substance that is in viscous liquid form at or substantially near room temperature (25° C.) and at atmospheric pressure (760 mmHg). Oils are both hydrophobic and lipophilic, have a high carbon and hydrogen content and are usually flammable and surface active. Oils may be animal, vegetable, or petrochemical in origin, and may be volatile or non-volatile. They are used for food, fuel, medical purposes, lubrication, and the manufacture of paints, plastics, and other materials.

Patch: A patch may be in multiple forms, including single and multi-layer forms, matrix forms, and reservoir forms, and has a finite size and shape.

Permeation Enhancer: A natural or synthetic molecule that facilitates the transport of co-administered active agents across biological membranes.

pH Modifier: A molecule or buffer used to achieve desired pH control in a formulation. Exemplary pH modifiers include acids, such as acetic acid, adipic acid, carbonic acid, citric acid, fumaric acid, phosphoric acid, sorbic acid, succinic acid, and tartaric acid, basic pH modifiers, such as sodium hydroxide, magnesium oxide, and tribasic potassium phosphate, and pharmaceutically acceptable salts thereof.

Pharmaceutically acceptable carriers: The pharmaceutically acceptable carriers useful in this disclosure are conventional. See Remington Pharmaceutical Sciences, by E. W. Martin, Mack Publishing Co., Easton, Pa., 19th Edition (1995). The nature of the carrier can depend on the particular mode of administration being employed. For instance, laundry detergent compositions usually include pharmaceutically and physiologically acceptable fluids such as water, physiological saline, balanced salt solutions, aqueous dextrose, glycerol or the like as a vehicle. In addition to biologically-neutral carriers, detergent compositions may also contain non-toxic auxiliary substances, such as wetting or emulsifying agents, preservatives, pH buffering agents and the like.

Plasticizer: A material that, when added to a polymer, imparts an increase in flexibility, workability, and other properties to the finished product. Exemplary plasticizers include, but are not limited to, glycerol, sorbitol, polyethylene glycol, polypropylene glycol, polyethylene-propylene glycol, and any combination thereof.

Polymer: Includes homopolymers, linear and branched polymer structures, crosslinked polymers, copolymers (which may or may not be crosslinked), block copolymers, alternating copolymers, random copolymers, and the like. Oligomers are polymers having a molecular weight below about 1000 Da.

Polyvinylpyrrolidone or PVP: A synthetic polymer consisting of linear 1-vinyl-2-pyrrolidinone groups; it is produced commercially as a series of products having mean molecular weights ranging from about 10,000 to about 700,000. The viscosity of solutions containing 10% or less PVP is essentially the same as that of water; solutions more concentrated than 10% become more viscous, depending on the concentration and molecular weight of the polymer used.

Pressure sensitive adhesive (PSA): A polymer material, which forms a strong adhesive bond to any surface with application of very slight external pressure over a short period of time (e.g., 1-5 seconds).

Skin: The largest organ in the body consisting of several layers. The skin plays an important role in biologic homeostasis, and is comprised of the epidermis and the dermis. The epidermis, which is composed of several layers beginning with the stratum corneum, is the outermost layer of the skin, and the deep dermis is the innermost skin layer. The skin has multiple functions, including thermal regulation, metabolic function (vitamin D metabolism), and immune functions. In humans, the usual thickness of the skin is 1-2 mm, although in some areas the skin may be more than 5 mm thick.

The epidermis provides the body's buffer zone against the environment and protection from trauma, excludes toxins and microbial organisms, and constitutes a semi-permeable membrane. The stratum corneum is an avascular, multilayer structure that functions as a barrier to the environment and prevents trans-epidermal water loss. Below the stratum corneum are the stratum lucidum, stratum granulosum, stratum germinativum, and stratum basale, each containing living cells with specialized functions. Dermal appendages, which include hair follicles, sebaceous and sweat glands, fingernails, and toenails, originate in the epidermis and protrude into the dermis hair follicles. The sebaceous glands are responsible for secretions that lubricate the skin, and sweat gland secretions control skin pH to prevent dermal infections. The sweat glands, dermal blood vessels, and small muscles control temperature on the surface of the body. Nerve endings in the skin include receptors for pain, touch, heat, and cold. The basement membrane separates and connects the epidermis and dermis. The dermis is a vascular structure that supports and nourishes the epidermis. In addition, there are sensory nerve endings in the dermis that transmit signals regarding pain, pressure, heat, and cold. The superficial dermis consists of extracellular matrix (collagen, elastin, and ground substances) and contains blood vessels, lymphatics, epithelial cells, connective tissue, muscle, fat, and nerve tissue. The vascular supply of the dermis is responsible for nourishing the epidermis and regulating body temperature. Fibroblasts are responsible for producing the collagen and elastin components of the skin, which give the skin its turgor. Fibronectin and hyaluronic acid are secreted by the fibroblasts. The deep dermis is located over the subcutaneous fat; it contains larger networks of blood vessels and collagen fibers to provide tensile strength. It also consists of fibroelastic connective tissue, which is composed mainly of collagen.

Skin Simulating Membrane: A semi-permeable membrane used to replicate the skin in diffusion testing.

Softener: A fluid composition that is added to some detergents to clean and soften clothing in a single step.

Subject: A living multi-cellular vertebrate organism, a category that includes human and non-human mammals, as well as birds (such as chickens and turkeys), fish, and reptiles. Exemplary subjects include mammals, such as human and non-human primates, rats, mice, dogs, cats, rabbits, cows, pigs, goats, horses, and the like.

Surface or Body Surface: A surface located on the human body or within a body orifice. Thus, a “body surface” includes, by way of example, skin, teeth, skin or mucosal tissue, including the interior surface of body cavities that have a mucosal lining.

Surfactant: Surfactants are compounds that lower the surface tension between two liquids, and are usually added to detergent compositions to improve wetting and cleaning performance by absorbing and emulsifying soil into water. Laundry detergents contain mostly anionic and non-ionic surfactants. Cationic surfactants are normally incompatible with anionic detergents, have poor cleaning efficiency, and are mainly used as fabric softeners, antistatic agents, and biocides. Zwitterionic surfactants are rarely employed in laundry detergents mainly for cost reasons. Nonionic surfactants may be alkoxylated or ethoxylated. Nonionic surfactants include, but are not limited to, alkyl polyglycosides (APG), surfactants of the amine oxide type, such as N-cocoalkyl-N,N-dimethylamine oxide and N-tallowalkyl-N,N-dihydroxyethylamine oxide, alkanolamides, polyhydroxy fatty acid amides, surfactants of the sulphonate type, such as alkylbenzenesulphonates, olefinsulphonates, disulphonates, alkanesulphonates, and alpha-sulpho fatty adds, fatty acid derivatives of amino acids, such as N-methyltaurine (taurides) and/or of N-methylglycine (sarcosides), sulphated fatty acid glycerol esters, such as sulphated glycerol esters of caproic acid, caprylic acid, capric acid, myristic add, lauric acid, palatine acid, stearic acid or behenic acid, sulphosuccinates, and saturated and unsaturated fatty acid soaps, such as the sodium, potassium or ammonium salts of lauric acid, myristic acid, palmitic acid, stearic acid, (hydrogenated) erucic acid, behenic acid, and of natural fatty acids, such as coconut, palm kernel, olive oil or tallow fatty acids. In some additional or alternative examples, one or more alternatives to palm oil and/or coconut oil may be used instead of palm oil and/or coconut oil.

Tacky: May be quantified using the values obtained in a PKI tack determination, a TRBT tack determination, or a PSA tack determination/Polyken Probe (Solutia, Inc.). The term “substantially non-tacky” means a hydrogel composition that has a tack value that is less than about 25 g/cm/sec; “slightly tacky” means a hydrogel composition that has a tack value in the range of about 25 g/cm/sec to about 100 g/cm/sec; and “tack” means a hydrogel composition that has a tack value of at least 100 g/cm/sec.

Under conditions sufficient to: A phrase that is used to describe any environment that permits the desired activity.

Water-Insoluble: A polymer, compound or composition, that has a solubility in water of less than 5%/w, less than 3%/w, or less than 1%/w, as measured in water at 20° C.

Water-Swellable: A polymer, substance or compound, that is capable of absorbing an amount of water greater than at least 25%/w of its own weight, or greater than at least 50%/w, upon immersion in an aqueous medium.

### Laundry Detergent Composition

A green laundry detergent composition is disclosed. The disclosed green laundry detergent composition is pH neutral and comprises a powerful cleansing surfactant, an organic and sustainable broad-spectrum antimicrobial agent, a high purity natural, renewable and biodegradable chelate, an emulsion polymer, a pH adjuster, enzymes, natural fragrances, natural essential oils, and water. The green laundry detergent composition provided herein is highly concentrated and its components act synergistically to achieve a superior cleansing effect, are less harsh on fabrics and do not fade colors as easily, such that the green laundry detergent composition provided herein can be used in small amounts. Therefore, the disclosed green laundry detergent composition is cost-effective and has much less of a harmful impact on the environment and the ecosystem than common detergent compositions.

In addition, components of the disclosed green laundry detergent composition are less irritating to the skin and are less likely to cause rash, redness, inflammation or discoloration of the skin, making the laundry detergent compositions particularly suitable to wash fabrics that come in contact with the skin of the elderly, infant and pediatric populations, who tend to have sensitive skin.

The disclosed green laundry detergent may comprise 20-25% (w/v) powerful cleansing surfactant; 0.4-0.8% (w/v) organic and sustainable broad-spectrum antimicrobial agent; 1.2-1.8% (w/v) high purity natural, renewable and biodegradable chelate; 1.5-2.0% (w/v) emulsion polymer; 0.025-0.04% (w/v) pH adjuster; 0.1-0.2% (w/v) enzymes; 2.7-3.5% (w/v) natural fragrances; 0.8-2.0% (w/v) natural essential oils; and up to 70% (w/v) water. In some additional or alternative examples, the disclosed green laundry detergent composition may comprise 2.5-7% (w/v) fragrances, wherein 3-6% of the fragrances are natural.

In some examples, the powerful cleansing surfactant is sodium laureth sulfate. The inventors found that sodium laureth sulfate provides a strong cleansing effect compared to derivative surfactants. In some alternative examples, the cleansing surfactant is sodium lauryl sulfate, while in some other alternative examples, the cleansing surfactant is an alkyl polyglycoside.

In some examples, the organic and sustainable broad-spectrum antimicrobial agent is a synergistic preservative blend consisting of benzoic acid, sorbitan caprylate and 1, 3-propanediol, such as NIPAGUARD® SCE. Such preservative blend exhibits anti-microbial activity against gram-positive and gram-negative bacteria, and also acts as a preservative in the disclosed green laundry detergent formulations. It is readily miscible with surfactants and emulsifiers, it is stable at pH 4.0-8.0 and over a wide temperature range, up to 80° C., and its solubility in water is below 0.05 g/l at 20° C.

In some examples, the high purity natural, renewable and biodegradable chelate is tetrasodium glutamate diacetate, such as DISSOLVINE® GL-47-S. The inventors found that such a chelate neutralizes calcium and hard metal ions found in water, boosts the performance of the surfactant and the preservative in the disclosed green laundry detergent composition, prevents discoloration of fabrics, it is more effective than non-green chelating agents, such as sodium-EDTA, and it does not irritate the skin upon contact of the washed fabric with a subject's skin.

In some examples, the emulsion polymer is an EPA-safe and highly efficient, hydrophobically-modified alkali-swellable emulsion polymer such as acrylates/beheneth-25 methacrylate copolymer (e.g., NOVETHIX™ L10 polymer). Such a polymer acts as a thickening and rheology control agent, has excellent compatibility and acts synergistically with surfactants in a wide pH range, and it is a safe chemical ingredient under the EPA Safer Choice Program, Safer Chemical Ingredient.

In some examples, the pH adjuster is sodium hydroxide. Such a pH adjuster is added to bring the pH of the disclosed green laundry detergent composition to a neutral range, between about 6.5 to about 7.0, close to the natural pH of water.

In some examples, the enzymes in the disclosed green laundry detergent composition comprise one or more of lipase, alpha-amylase and protease. These enzymes degrade stubborn stains composed of proteins, such as milk, cocoa, blood, egg yolk, and grass, fats, such as chocolate and oils, and starch, such as flour and potato stains. The presence of these enzymes in the disclosed green laundry detergent composition renders the green laundry detergent composition provided herein effective at lower water temperatures (37° C.), and this results in less use of hot water and in great savings in energy and cost.

In some examples, the natural fragrances comprise perfumes. In some examples, the natural fragrances comprise natural essential oils, such as one or more of: cedarwood essential oil, balsam fir essential oil, and lavender essential oil.

In some examples, the disclosed green laundry detergent composition comprises 21.719% (w/v) sodium laureth sulfate; 1.493% (w/v) NIPAGUARD® SCE-sorbitan caprylate, propanediol and benzoic acid; 1.9% (w/v) tetrasodium glutamate diacetate; 2.986% (w/v) acrylates/beheneth-25 methacrylate copolymer; 0.543% (w/v) sodium hydroxide; 0.027% (w/v) lipase; 0.03% (w/v) alpha-amylase; 0.033% (w/v) protease; 6.027% (w/v) natural fragrances; 0.03% (w/v) cedarwood essential oil; 0.027% (w/v) balsam fir essential oil; 0.027% (w/v) lavender essential oil; and 65.157% water.

In some examples, the detergent compositions provided herein may further comprise additional ingredients. Suitable additional ingredients include, but are not limited to, natural bleaching agents, natural antibacterial agents, anti-oxidants, color stabilizers, natural fatty acids, such as tartaric acid, oleic acid, lauric acid, maleic acid, and any combination thereof, one or more natural essential oils, such as L-menthol, chuanxiong oil, clove oil, cinnamon oil, turpentine oil, eucalyptus oil, and any combination thereof, lubricants, preservatives, stabilizers, wetting agents, emulsifiers, salts for influencing osmotic pressure, buffers, colorants, flavorants and/or fragrances and the like which do not deleteriously react with the active compounds.

Exemplary anti-oxidants include, but are not limited to, ascorbic acid (vitamin C) and its salts, ascorbyl esters of fatty acids, ascorbic acid derivatives, such as magnesium ascorbyl phosphate, sodium ascorbyl phosphate, and ascorbyl sorbate, tocopherol (vitamin E), tocopherol sorbate, tocopherol acetate, other esters of tocopherol, butylated hydroxy benzoic acids and their salts, bioflavonoids, curcumin, lysine, methionine, proline, superoxide dismutase, silymarin, tea extracts, grape extracts, melanin, and rosemary extracts. The antioxidant may be present at a concentration from 0.1% to 10% w/w of the green laundry detergent composition.

The disclosed green laundry detergent compositions may be in liquid or in solid form. Liquid detergent compositions may be in the form of gel, hydrogel, emulsion, cream or water solutions. Solid forms may comprise tablets, powder, single-phase or multi-phase unit doses, pouches, pods, paste, bars, or flakes.

The disclosed green laundry detergent compositions are suitable for use in hand washing as well as in laundry machines.

Thus, the green laundry detergent compositions provided herein achieve deep cleansing, significantly reduce cost and are eco-friendly.

### Method of Making the Disclosed Green Laundry Detergent Composition

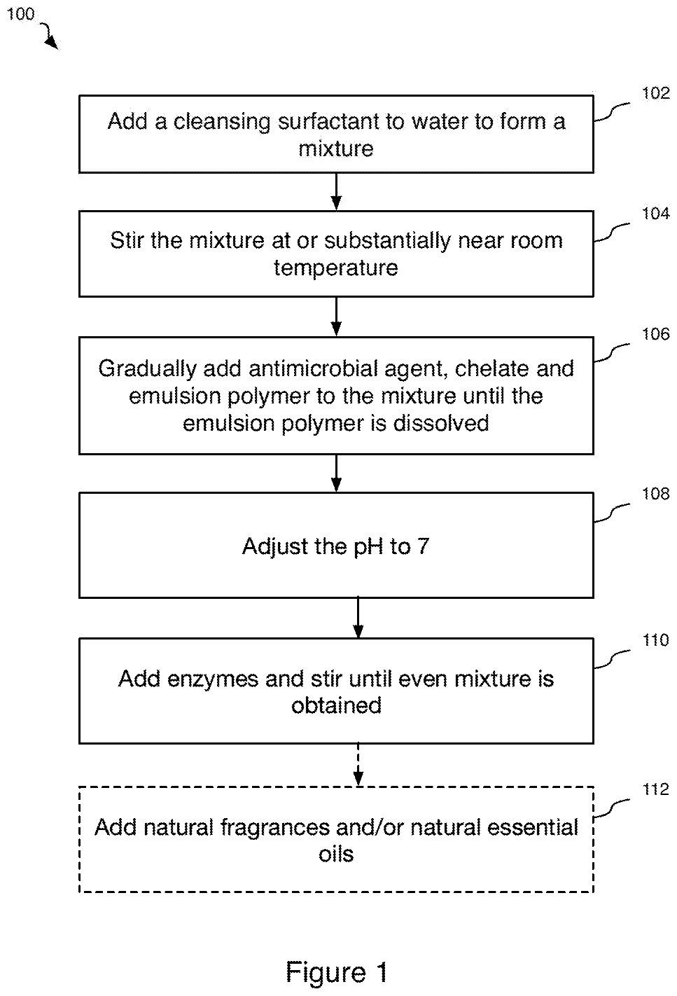

FIG. 1 is a flow chart illustrating an exemplary method 100 of making a green laundry detergent composition, in accordance with some embodiments.

At step 102, the method includes adding cleansing surfactant to water. At step 104, the method includes stirring the resulting mixture at or substantially near room temperature (25° C.) to obtain a mixture. At step 106, the method includes gradually adding organic and sustainable broad-spectrum antimicrobial agent, high purity natural, renewable and biodegradable chelate, and an emulsion polymer, and stirring the mixture until the emulsion polymer is dissolved. At step 108, the method includes adjusting the pH to 7 with the pH adjuster. At step 110, the method includes adding enzymes to the mixture and stirring until an even mixture is obtained. At optional step 112, the method optionally includes adding natural fragrances and natural essential oils to the mixture, and stirring to obtain an even mixture with the desired viscosity.

In some examples, the disclosed method produces a detergent composition that may comprise 20-25% (w/v) powerful cleansing surfactant; 0.4-0.8% (w/v) organic and sustainable broad-spectrum antimicrobial agent; 1.2-1.8% (w/v) high purity natural, renewable and biodegradable chelate; 1.5-2.0% (w/v) emulsion polymer; 0.025-0.04% (w/v) pH adjuster; 0.1-0.2% (w/v) enzymes; 2.7-3.5% (w/v) natural fragrances; 0.8-2.0% (w/v) natural essential oils; and up to 70% (w/v) water. In some additional or alternative examples, the disclosed green laundry detergent composition may comprise 2.5-7% (w/v) fragrances, wherein 3-6% of the fragrances are natural.

In some examples, the powerful cleansing surfactant is sodium laureth sulfate, which, the inventors found, provides a strong cleansing effect compared to derivative surfactants. In some alternative examples, the cleansing surfactant is sodium lauryl sulfate, while in some other alternative examples, the cleansing surfactant is an alkyl polyglycoside.

In some examples, the organic and sustainable broad-spectrum antimicrobial agent is a synergistic preservative blend consisting of benzoic acid, sorbitan caprylate and 1, 3-propanediol, such as NIPAGUARD® SCE. Such preservative blend exhibits anti-microbial activity against gram-positive and gram-negative bacteria, and also acts as a preservative in the disclosed green laundry detergent formulations. It is readily miscible with surfactants and emulsifiers, it is stable at pH 4.0-8.0 and at temperatures as high as up to 80° C., and its solubility in water is below 0.05 g/l at 20° C.

In some examples, the high purity natural, renewable and biodegradable chelate is a tetrasodium glutamate diacetate, such as DISSOLVINE® GL47-S. The inventors found that such a chelate neutralizes calcium and hard metal ions found in water, boosts the performance of the surfactant and the preservative in the disclosed green laundry detergent composition, prevents discoloration of fabrics, it is more effective than non-green chelating agents, such as sodium-EDTA, and it does not irritate the skin upon contact of the washed fabric with a subject's skin.

In some examples, the emulsion polymer is an EPA-safe and highly efficient, hydrophobically-modified alkali-swellable emulsion polymer, such as acrylates/beheneth-25 methacrylate copolymer (e.g., NOVETHIX™ L10 polymer). Such a polymer acts as a thickening and rheology control agent, has excellent compatibility and acts synergistically with surfactants in a wide pH range, and it is a safe chemical ingredient under the EPA Safer Choice Program, Safer Chemical Ingredient.

In some examples, the pH adjuster is sodium hydroxide. Such a pH adjuster is added to bring the pH of the disclosed green laundry detergent composition to a neutral range, between about 6.5 to about 7.0, close to the natural pH of water.

In some examples, the enzymes in the disclosed green laundry detergent composition comprise one or more of lipase, alpha-amylase and protease. These enzymes degrade stubborn stains composed of proteins, such as milk, cocoa, blood, egg yolk, and grass, fats, such as chocolate and oils, and starch, such as flour and potato stains. The presence of these enzymes in the disclosed green laundry detergent composition renders the green laundry detergent composition provided herein effective at lower water temperatures (37° C.), and this results in less use of hot water and in great savings in energy and cost.

In some examples, the natural fragrances comprise perfumes. In some examples, the natural fragrances comprise one or more natural essential oils, such as cedarwood essential oil, balsam fir essential oil, and lavender essential oil.

In some examples, the method as provided herein produces a green laundry detergent composition that comprises 21.719% (w/v) sodium laureth sulfate; 1.493% (w/v) NIPAGUARD® SCE-sorbitan caprylate, propanediol and benzoic acid; 1.9% (w/v) tetrasodium glutamate diacetate; 2.986% (w/v) acrylates/beheneth-25 methacrylate copolymer; 0.543% (w/v) sodium hydroxide; 0.027% (w/v) lipase; 0.03% (w/v) alpha-amylase; 0.033% (w/v) protease; 6.027% (w/v) natural fragrances; 0.03% (w/v) cedarwood essential oil; 0.027% (w/v) balsam fir essential oil; 0.027% (w/v) lavender essential oil; and 65.157% water.

In some examples, the disclosed method may further comprise adding additional ingredients to the composition. Suitable additional ingredients may include, but are not limited to, natural bleaching agents, natural antibacterial agents, anti-oxidants, color stabilizers, natural fatty acids, such as tartaric acid, oleic acid, lauric acid, maleic acid, and any combination thereof, one or more natural essential oils, such as L-menthol, chuanxiong oil, clove oil, cinnamon oil, turpentine oil, eucalyptus oil, and any combination thereof, lubricants, preservatives, stabilizers, wetting agents, emulsifiers, salts for influencing osmotic pressure, buffers, colorants, flavorants and/or fragrances and the like which do not deleteriously react with the active compounds.

Exemplary anti-oxidants include, but are not limited to, ascorbic acid (vitamin C) and its salts, ascorbyl esters of fatty acids, ascorbic acid derivatives, such as magnesium ascorbyl phosphate, sodium ascorbyl phosphate, and ascorbyl sorbate, tocopherol (vitamin E), tocopherol sorbate, tocopherol acetate, other esters of tocopherol, butylated hydroxy benzoic acids and their salts, bioflavonoids, curcumin, lysine, methionine, proline, superoxide dismutase, silymarin, tea extracts, grape extracts, melanin, and rosemary extracts. The antioxidant may be present at a concentration from 0.1% to 10% w/w of the green laundry detergent composition.

The disclosed green laundry detergent compositions may be in liquid or in solid form. Liquid detergent compositions may be in the form of gel, hydrogel, emulsion, cream or water solutions, and can be prepared by adding suitable carriers according to methods known in the art. Solid forms may comprise tablets, powder, single-phase or multi-phase unit doses, pouches, pods, paste, bars, or flakes, and may be prepared by methods known in the art, such as, for example, by pouring the composition prepared by the method provided herein into a backing layer to obtain a cast and by solidifying the cast by solvent evaporation.

The disclosed green laundry detergent compositions are suitable for use in hand washing as well as in laundry machines.

The method provided herein produces a laundry detergent composition that comprises natural components in high concentration, thus making the laundry detergent compositions provided herein very cost effective. Moreover, the laundry detergent compositions produced by the method provided herein contain green ingredients that act synergistically to cleanse and are not harsh on fabrics and do not fade colors, and thus are eco-friendly.

### Method of Using the Disclosed Green Laundry Detergent Composition

Also provided herein is a method of using the disclosed detergent compositions, wherein the method comprises diluting the disclosed detergent composition in water to form a detergent composition solution, adding soiled material to the detergent composition solution, soaking and shaking the soiled material in the detergent composition solution for 30 minutes to 2 hours, rinsing the material with water, and squeezing the water out of the material. The method may be performed by hand or with a washing machine. Example of soiled material that may be washed by the disclosed method include, but are not limited to, natural or artificial fibers, including natural, artificial, and synthetic fibers, such as, but not limited to, cotton, linen, wool, polyester, nylon, silk, acrylic, and any combinations thereof.

### EXAMPLES

### Example 1: Method of Making the Disclosed Green Laundry Detergent Composition

A liquid matrix comprising 21.719% (w/v) sodium laureth sulfate; 1.493% (w/v) NIPAGUARD® SCE-sorbitan caprylate, propanediol and benzoic acid; 1.9% (w/v) tetrasodium glutamate diacetate; 2.986% (w/v) acrylates/beheneth-25 methacrylate copolymer; 0.543% (w/v) sodium hydroxide; 0.027% (w/v) lipase; 0.03% (w/v) alpha-amylase; 0.033% (w/v) protease; 6.027% (w/v) natural fragrances; 0.03% (w/v) cedarwood essential oil; 0.027% (w/v) balsam fir essential oil; 0.027% (w/v) lavender essential oil; and 65.157% water is poured into a backing layer and solidified by solvent evaporation. The pod thus formed is circular, and has a diameter of 4 cm and a final thickness of approximately 5 cm.

### Example 2: Use of the Disclosed Green Laundry Detergent Composition

Two identical white garments are stained with a soiled material containing tomato sauce, fried oil, orange juice, cereals soaked in milk, meat sauce, peach and carburetor oil. The two textiles are then separately washed in identical washing machines. The first garment is washed using the disclosed green laundry detergent composition. The second garment is washed with a detergent composition comprising a synthetic derivative surfactant in place of sodium laureth sulfate (or, alternatively, in place of sodium lauryl sulfate or an alkyl polyglycoside), sodium EDTA in place of DISSOLVINE® GL-47-S, and acryl methacrylate in place of acrylates/beheneth-25 methacrylate copolymer. At the end of the washing cycle, the two garments are dried and examined. The first garment is perfectly clean and shows no residual spots or marks. The second garment is only partially clean and shows residual spots and marks.

### Example 3: Effect of the Disclosed Green Laundry Detergent Composition on Human Skin

Two identical garments are stained, washed and dried as described in Example 2. A human subject with sensitive skin is instructed to wear the first garment washed with the disclosed green laundry detergent composition on day 1 for 8 hours, change for the night, and wear the second garment washed with a detergent composition comprising a synthetic derivative surfactant, sodium EDTA, and aryl methacrylate for 8 hours the following day (day 2). At the end of the first day, the subject shows no rash, redness, inflammation or discoloration of the skin. At the end of the second day, the subject shows multiple signs of rash, redness, inflammation and discoloration of the skin.

In view of the many possible embodiments to which the principles of our invention may be applied, it should be recognized that illustrated embodiments are only examples of the invention and should not be considered a limitation on the scope of the invention. Rather, the scope of the invention is defined by the following claims. We therefore claim as our invention all that comes within the scope and spirit of these claims.

1. A green laundry detergent composition comprising 21.719% (w/v) sodium laureth sulfate; 1.493% (w/v) sorbitan caprylate in propanediol and benzoic acid; 1.9% (w/v) tetrasodium glutamate diacetate; 2.986% (w/v) acrylates/beheneth-25 methacrylate copolymer; 0.543% (w/v) sodium hydroxide; 0.027% (w/v) lipase; 0.03% (w/v) alpha-amylase; 0.033% (w/v) protease; 6.027% (w/v) natural fragrances; 0.03% (w/v) cedarwood essential oil; 0.027% (w/v) balsam fir essential oil; 0.027% (w/v) lavender essential oil; and 65.157% water.

2. A green laundry detergent composition comprising 20-25% (w/v) cleansing surfactant; 0.4-0.8% (w/v) organic and sustainable antimicrobial agent; 1.2-1.8% (w/v) biodegradable chelate; 1.5-2.0% (w/v) emulsion polymer; 0.025-0.04% (w/v) pH adjuster; 0.1-0.2% (w/v) enzymes; 2.7-3.5% (w/v) natural fragrances; 0.8-2.0% (w/v) natural essential oils; and up to 70% (w/v) water.

3. The green laundry detergent composition of claim 2, wherein the cleansing surfactant is sodium laureth sulfate.

4. The green laundry detergent composition of claim 2, wherein the cleansing surfactant is one of: sodium laureth sulfate, sodium lauryl sulfate, or an alkyl polyglycoside.

5. The green laundry detergent composition of claim 2, wherein the organic and sustainable antimicrobial agent is a synergistic blend of benzoic acid in sorbitan caprylate and propanediol.

6. The green laundry detergent composition of claim 2, wherein the renewable and biodegradable chelate is tetrasodium glutamate diacetate.

7. The green laundry detergent composition of claim 2, wherein the emulsion polymer is acrylates/beheneth-25 methacrylate copolymer.

8. The green laundry detergent composition of claim 2, wherein the pH adjuster is sodium hydroxide and wherein the green laundry detergent composition has a pH between 6.5 and 7.0.

9. The green laundry detergent composition of claim 2, wherein the enzymes comprise one or more of: lipase, alpha-amylase and protease.

10. The green laundry detergent composition of claim 2, wherein the natural fragrances comprise perfumes.

11. The green laundry detergent composition of claim 2, wherein the natural essential oils comprise one or more of: cedarwood essential oil, balsam fir essential oil, and lavender essential oil.

12. The green laundry detergent composition of claim 2, wherein the green laundry detergent composition further comprises one or more of natural bleaching agents, natural antibacterial agents, anti-oxidants, color stabilizers, natural fatty acids, one or more natural essential oils, lubricants, preservatives, stabilizers, wetting agents, emulsifiers, salts, buffers, colorants, flavorants and fragrances.

13. The green laundry detergent composition of claim 12, wherein the anti-oxidants comprise one or more of ascorbic acid, ascorbic acid salts, ascorbyl esters of fatty acids, magnesium ascorbyl phosphate, sodium ascorbyl phosphate, ascorbyl sorbate, tocopherol, tocopherol sorbate, tocopherol acetate, butylated hydroxy benzoic acids, bioflavonoids, curcumin, lysine, methionine, proline, superoxide dismutase, silymarin, tea extracts, grape extracts, melanin, and rosemary extracts.

14. The green laundry detergent composition of claim 12, wherein the one or more natural essential oils comprise L-menthol, chuanxiong oil, clove oil, cinnamon oil, turpentine oil, eucalyptus oil, and any combination thereof.

15. The green laundry detergent composition of claim 12, wherein the one or more of natural fatty acids comprise tartaric acid, oleic acid, lauric acid, maleic acid, and any combination thereof.

16. The green laundry detergent composition of claim 2, wherein the green laundry detergent composition is in liquid or in solid form.

17. The green laundry detergent composition of claim 16, wherein the green laundry detergent composition is in the form of gel, hydrogel, emulsion, cream or water solution.

18. The green laundry detergent composition of claim 16, wherein the green laundry detergent composition is in the form of tablets, powder, single-phase or multi-phase unit doses, pouches, pods, paste, bars, or flakes.

19. The green laundry detergent composition of claim 2, wherein the green laundry detergent composition is not harsh on fabrics, does not fade colors and is not irritating to a mammal's skin.

20. The green laundry detergent composition of claim 19, wherein the mammal is a human.

21. A method of making a green laundry detergent composition, wherein the method comprises first adding a cleansing surfactant to water to form a mixture and stirring the mixture at or substantially near room temperature (25° C.); gradually adding an organic and sustainable broad-spectrum antimicrobial agent, a renewable and biodegradable chelate and an emulsion polymer to the mixture and stirring the mixture until the emulsion polymer is dissolved; adjusting the pH to 7 with the pH adjuster; then adding enzymes and stirring until an even mixture is obtained; and then adding natural fragrances and the natural essential oils and stirring to obtain an even mixture.

22. The method of claim 21, wherein the method produces a detergent composition comprising 20-25% (w/v) cleansing surfactant; 0.4-0.8% (w/v) organic and sustainable broad-spectrum antimicrobial agent; 1.2-1.8% (w/v) renewable and biodegradable chelate; 1.5-2.0% (w/v) emulsion polymer; 0.025-0.04% (w/v) pH adjuster; 0.1-0.2% (w/v) enzymes; 2.7-3.5% (w/v) natural fragrances; 0.8-2.0% (w/v) natural essential oils; and up to 70% (w/v) water.

23. The method of claim 21, wherein the cleansing surfactant is sodium laureth sulfate.

24. The green laundry detergent composition of claim 21, wherein the cleansing surfactant is one of: sodium laureth sulfate, sodium lauryl sulfate, or an alkyl polyglycoside.

25. The method of claim 21, wherein the organic and sustainable antimicrobial agent is a synergistic blend of benzoic acid in sorbitan caprylate and propanediol.

26. The method of claim 21, wherein the renewable and biodegradable chelate is tetrasodium glutamate diacetate.

27. The method of claim 21, wherein the emulsion polymer is acrylates/beheneth-25 methacrylate copolymer.

28. The method of claim 21, wherein the pH adjuster is sodium hydroxide and wherein the green laundry detergent composition has a pH between 6.5 and 7.0.

29. The method of claim 21, wherein the enzymes comprise one or more of: lipase, alpha-amylase and protease.

30. The method of claim 21, wherein the natural fragrances comprise perfumes.

31. The method of claim 21, wherein the natural essential oils comprise one or more of: cedarwood essential oil, balsam fir essential oil, and lavender essential oil.

32. The method of claim 21, further comprising adding one or more of natural bleaching agents, natural antibacterial agents, anti-oxidants, color stabilizers, natural fatty acids, one or more natural essential oils, lubricants, preservatives, stabilizers, wetting agents, emulsifiers, salts, buffers, colorants, flavorants and fragrances to the mixture.

33. The method of claim 32, wherein the anti-oxidants comprise one or more of ascorbic acid, ascorbic acid salts, ascorbyl esters of fatty acids, magnesium ascorbyl phosphate, sodium ascorbyl phosphate, ascorbyl sorbate, tocopherol, tocopherol sorbate, tocopherol acetate, butylated hydroxy benzoic acids, bioflavonoids, curcumin, lysine, methionine, proline, superoxide dismutase, silymarin, tea extracts, grape extracts, melanin, and rosemary extracts.

34. The method of claim 32, wherein the one or more natural essential oils comprise L-menthol, chuanxiong oil, clove oil, cinnamon oil, turpentine oil, eucalyptus oil, and any combination thereof.

35. The method of claim 32, wherein the one or more of natural fatty acids comprise tartaric acid, oleic acid, lauric acid, maleic acid, and any combination thereof.

36. The method of claim 21, wherein the method further comprises producing the green laundry detergent composition in liquid or in solid form.

37. The method of claim 36, wherein the method comprises producing the green laundry detergent composition in the form of gel, hydrogel, emulsion, cream or water solution.

38. The method of claim 36, wherein the method comprises producing the green laundry detergent composition in the form of tablets, powder, single-phase or multi-phase unit doses, pouches, pods, paste, bars, or flakes.

39. The method of claim 21, wherein the method produces a green laundry detergent composition that is not harsh on fabrics, does not fade colors and is not irritating to a mammal's skin.

40. The method of claim 39, wherein the mammal is a human.

41. A method of washing a soiled fabric, wherein the method comprises diluting the green laundry detergent composition of claim 2 in water to form a detergent composition solution, adding soiled material to the detergent composition solution, soaking and shaking the soiled material in the detergent composition solution for 30 minutes to 2 hours, rinsing the material with water, and squeezing the water out of the material.

42. The method of claim 41, wherein washing is performed by hand or with a washing machine.

43. The method of claim 41, wherein the soiled material is one or more of natural, artificial, synthetic fibers.

44. The method of claim 43, wherein the natural, artificial and synthetic fabrics comprise cotton, linen, wool, polyester, nylon, silk, acrylic, and any combinations thereof.

45. A green laundry detergent composition comprising 20-25% (w/v) cleansing surfactant; 0.4-0.8% (w/v) organic and sustainable antimicrobial agent; 1.2-1.8% (w/v) biodegradable chelate; 1.5-2.0% (w/v) emulsion polymer; 0.025-0.04% (w/v) pH adjuster; 0.1-0.2% (w/v) enzymes; and up to 70% (w/v) water.

46. The green laundry detergent composition of claim 45, further comprising 2.5-7% (w/v) fragrances, wherein 3-6% of the fragrances are natural.

47. The green laundry detergent composition of claim 45, further comprising 0.8-2.0% (w/v) natural essential oils.
